(19) United States
(12) Patent Application Publication
(10) Pub. No.: US 2009/0254670 A1
(43) Pub. Date: Oct. 8, 2009

(54) PROVIDING ACCESS TO NETWORK APPLICATIONS FOR STANDARDIZED CLIENTS

(75) Inventors: Jacob Kim, Issaquah, WA (US); John Bruno, Snoqualmie, WA (US); Thomas Jeyaseelan, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/099,154

(22) Filed: Apr. 8, 2008

(51) Int. Cl. G06F 15/16

(52) U.S. Cl. 709/230

(57) ABSTRACT

A method for providing access to a network application for a standardized client. A hypertext transfer protocol (HTTP) request may be received from a standardized client. A resource request based on the HTTP request may be created. The resource request may be sent to the network application. A response may be received from the network application. A client response may be created based on the response. The client response may be sent to the standardized client.

### BACKGROUND

A network application, such as a Web application, is typically accessible to users via a client application. The client may be implemented as part of, or alongside, the Web application. Alternately, the developer of the Web application can publish, or make available, an application programming interface (API) so that other developers can create clients for the Web application. Some clients are standardized to particular formats, such as Really Simple Syndication (RSS) and ATOM Syndication (ATOM). Standardized clients may aggregate information about changes to a website so that a user can keep up to date on a site's content without having to actually visit the site.

### SUMMARY

Described herein are implementations of various technologies for providing access to a network application for standardized clients. In one implementation, the network application may be a Web application. In operation, an application programming interface (API) framework may receive a hypertext transfer protocol (HTTP) request from a standardized client, such as an RSS client. In another implementation, the API framework may receive an HTTP over Secure Socket Layer (HTTPS) request from a standardized client. In response, the API framework may create a resource request based on the HTTP or HTTPS request, and send the resource request to the network application. In one implementation, the resource request may be a representational state transfer (REST) request. The API framework may then receive a response from the network application, and create a client response based on the response. The API framework may then send the client response to the standardized client. In this manner, the API framework may provide access to network applications for standardized clients.

In one implementation, the API framework may encapsulate the HTTP or HTTPS request as an object within the resource request. In another implementation, the response may include a status message that indicates success or failure of the resource request.

In yet another implementation, the client response may be based on a format of the standardized client. Thus, the response may be translated into the format of the standardized client. In translating the response, data within the response may be serialized based on the format of the standardized client, and the serialized data may be included in the client response. The format may be really simple syndication (RSS), ATOM Syndication, JavaScript Object Notation, extensible markup language (XML), or binary XML.

In one implementation, the HTTP request may specify the network application, an application resource associated with the network application, and the format of the standardized client. In another implementation, access to the application resource may be restricted based on a policy of the network application.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a computing system in which the various technologies described herein may be incorporated and practiced.

FIG. 2 illustrates a schematic diagram of an example application server resource hierarchy for which the various technologies described herein may be incorporated and practiced.

FIG. 3 illustrates a flow chart of a method for processing a request from a standardized client to a network application in accordance with one or more implementations of various techniques described herein.

### DETAILED DESCRIPTION

In general, one or more implementations of various technologies described herein are directed to extending external APIs to standardized clients. In operation, an API framework server (framework) may receive a hypertext transfer protocol (HTTP) request for accessing a network application from a client standardized to a particular format. In response, the framework may invoke a method for accessing the network application. The framework may receive an application response from the network application and send the application response to the client in the particular standardized format.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

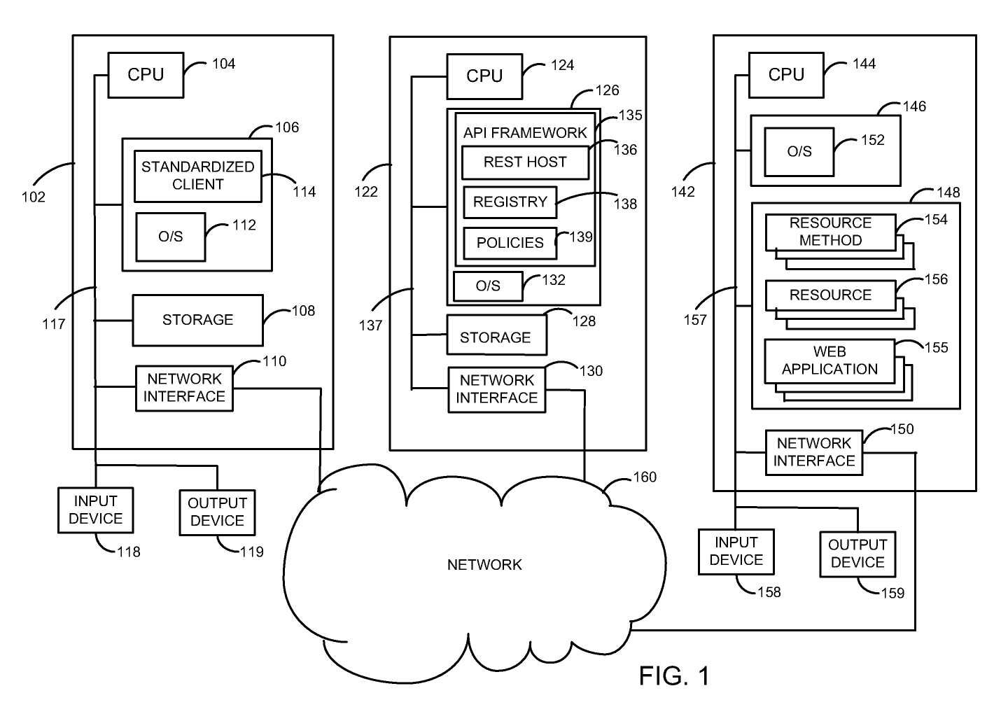

FIG. 1 illustrates a schematic diagram of a computing system 100 in which the various technologies described herein may be incorporated and practiced. The computing system 100 includes a client 102, an API framework server 122, and an application server 142 remotely connected via a network 160. The network 160 may be any network or collection of networks that link remote computers such as a local area network or a wide area network. In one implementation, the network 160 is the Internet. Although the client 102, API framework server 122, and application server 142 may be conventional desktops or server computers, as described above, other computer system configurations may be used.

The client computer 102 may include a central processing unit (CPU) 104, a system memory 106 and a system bus 117 that couples various system components including the system memory 106 to the CPU 104. It should be noted that the CPU 104 may include Virtualized systems (Virtual Machines, Processors), as well as CPU Cores and Hyper-threaded processors within a physical CPU. Although only one CPU is illustrated in FIG. 1, it should be understood that in some implementations the client computer 102 may include more than one CPU. The system bus 117 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The client computer 102 may further include a storage 108, which may be connected to the bus 117. Examples of storage 108 include a hard disk drive for reading from and writing to a hard disk, a magnetic disk drive for reading from and writing to a removable magnetic disk, and an optical disk drive for reading from and writing to a removable optical disk, such as a CD ROM or other optical media. The storage 108 and associated computer-readable media may provide nonvolatile storage of computer-readable instructions, data structures, program modules and other data for the client computer 102.

It should be appreciated by those skilled in the art that the client computer 102 may also include other types of storage 108 and associated computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the client computer 102. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored in memory 106, including an operating system 112 and a standardized client 114. The operating system 112 may be any suitable operating system that may control the operation of a networked personal or server computer, such as Windows® Vista , Mac OS® X, Unix-variants (e.g., Linux® and BSD®), and the like. The standardized client 114 may be software that presents information about resources 156 (stored on application servers 142) to a user, where the client is standardized to a particular format. Examples of standardized formats include really simple syndication (RSS), ATOM Syndication, ATOM Publishing Protocol (APP), JavaScript Object Notation (JSON), extensible markup language (XML), and binary XML. In one implementation, the standardized client 114 is an RSS reader.

A user may enter commands and information into the client computer 102 through an input device 118. Examples of input devices 118 include keyboards, pointing devices, microphones, joysticks, game pads, satellite dishes, scanners, or the like. These and other input devices may be connected to the CPU 104 through the system bus 117. A user may receive information from the client computer 102 via an output device 119. Examples of output devices 119 include displays, speakers, printers, and fax machines.

The client computer 102 may be connected to the network 160 through a network interface 110. It will be appreciated that the network connections shown are exemplary and other means of establishing a communications link between the computers may be used.

The API framework server 122 and application server 142 may be similarly constructed as the client computer 102. The API framework server 122 may contain a CPU 124, system memory 126, storage 128, and network interface 130. Similarly, the application server 142 may contain a CPU 144, system memory 146, storage 148, and network interface 150.

At the application server 142, the system memory 146 may include an operating system 152. The storage 148 may include a Web application 155, resource methods 154 and resources 156. The Web application 155 may be software for sharing and managing resources 156 for users of clients 102. Examples of Web applications 155 include Weblogs (blogs), discussion boards, e-mail programs, and software for sharing media, such as photographs. In one implementation, the Web application 155 may be a Web service.

It should be noted that the Web application 155 is merely a specific example of a network application, and that any application accessible via a hypertext transfer protocol (HTTP) or HTTP over Secure Socket Layer (HTTPS) may be used in various implementations described herein. The resources 156 managed in the example Web applications include blog or discussion board posts, e-mails, e-mail folders, and the photographs or other media shared. Those skilled in the art recognize that a wide array of Web applications 155 and resources 156 are possible, and these examples are provided for purposes of illustration and are not intended to be limiting.

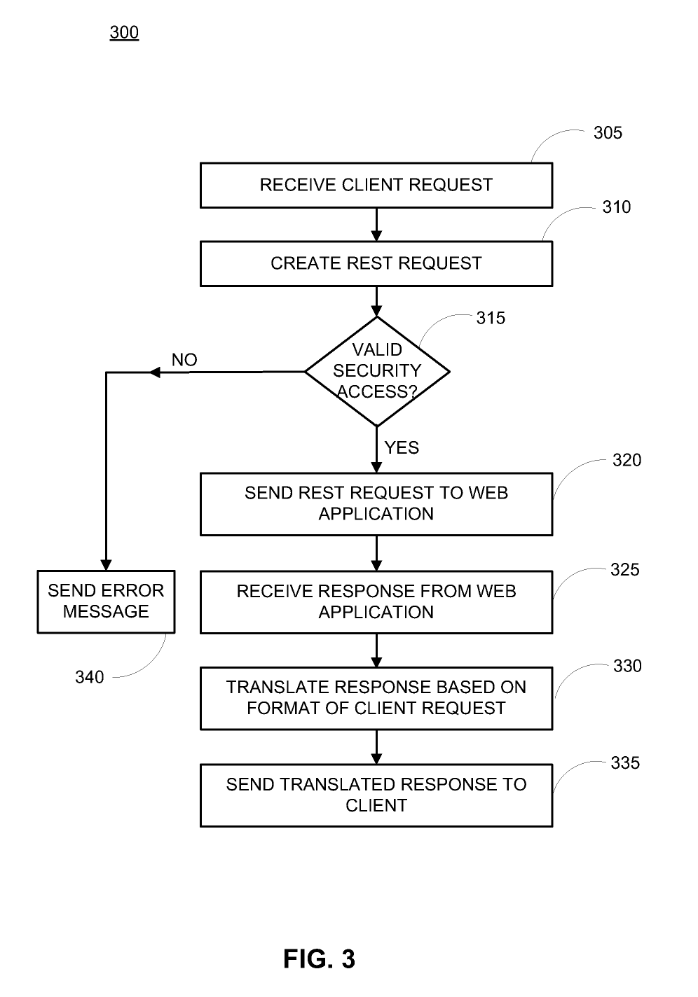

Resource methods 154 on the application server 142 may be invoked by a representational state transfer (REST) host 136 (stored in the API framework server 122) based on a mapping included in the registry 138. The REST host 136 is software that handles communication requests between the standardized client 114 and the Web application 155. The REST host 136 will be described in more detail in the paragraphs below with reference to FIG. 3. Each resource method 154 performs one create, read, update, or delete (CRUD) operation for one or more of the resources 156.

At the API framework server 122, the system memory 126 may include an operating system 132 and an API framework 135. The API framework 135 may be software that includes the REST host 136, a registry 138, and policies 139. The API framework 135 may handle communications between the standardized client 114 and the Web application 155. The registry 138 may specify Web applications 155 available to standardized clients via the API framework server 122. The registry 138 may further map HTTP and HTTPS requests for the resources 156 to specific resource methods 154 for the Web application 155. In one implementation, the registry 138 may be the Windows® registry. However, it should be understood that other types of registry may be used in various implementations described herein. The policies 139 may include rules (applied by the REST host 136) for restricting access to the Web application 155 and/or the resources 156.

While the computing system 100 illustrates the API framework server 122 and application server 142 as separate computers, it should be understood that in some implementations, the functionalities performed by the API framework server 122 and the application server 142 may be performed by a single computer. For example, the Web application 155, resource methods 154, and resources 156 may alternatively be stored in the storage 128.

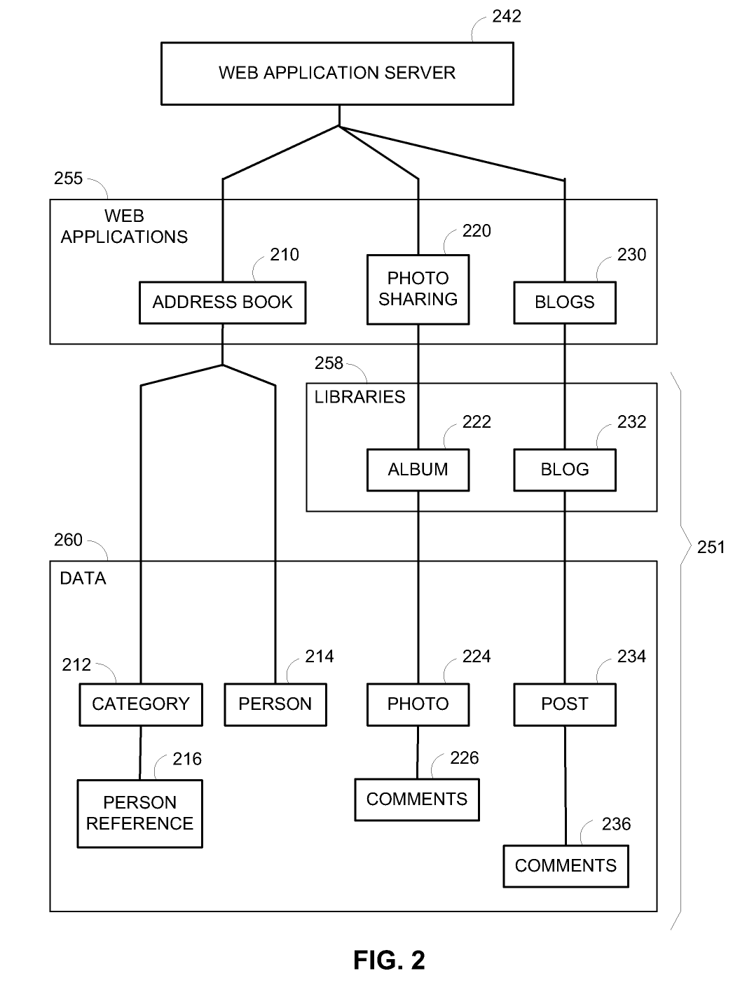

FIG. 2 illustrates a schematic diagram 200 of a resource hierarchy on a Web application server 242 for which the various technologies described herein may be incorporated and practiced. The resource hierarchy represents a namespace taxonomy by which the standardized client 114 identifies the Web application 155 and the resource 156 for a particular request. For example, the standardized client 114 may issue a request that specifies a centralized domain for the API framework server 122 alongside the Web application 155 and the resource 156.

As shown, a Web application server 242 may have more than one Web application 255. Some examples of Web applications 255 include an address book 210, a photo sharing application 220, and a blogs application 230. Each application 255 has access to different types of resources 256. In one implementation, resources 256 can include data 260 and organizational-type resources, such as libraries 258. For example, the photo sharing application 220 may organize photos 224 (and associated comments 226) into albums 222. Similarly, the blogs application 230 may organize posts 234 and comments 236 into different blogs 232.

In another implementation, an application, such as the address book 210, may access data 260 without the use of libraries 258. For example, the address book 210 may access data 260, such as a person 214, by using other data 260 available to the address book 210, such as a category 212, and a person reference 216. In such a scenario, the person reference 216 may represent a pointer to each person 214 in a particular category 212.

In a system that includes a framework for extending Web applications to standardized clients, resource methods 154 may be stored on the application server 142 for each resource 256. Accordingly, in the example shown, resource methods 154 (one each for CREATE, READ, UPDATE, and DELETE) are stored for the album 222 and blog 232 libraries. The resource methods 154 are also stored for each of the category 212, person reference 216, person 214, photo 224, comments 226, post 234, and comments 236 data.

FIG. 3 illustrates a flow chart of a method 300 for processing a request from the standardized client 114 for accessing the Web application 155 in accordance with one or more implementations of various techniques described herein. In one implementation, the method 300 may be performed by the REST host 136.

Representational State Transfer (REST) is an architectural methodology for distributed hypermedia systems such as the World Wide Web. REST describes any simple interface that transmits domain-specific data over hypertext transfer protocol (HTTP) without an additional messaging layer.

At step 305, the REST host 136 may receive a request from the standardized client 114 to access a network application. In one implementation, the request may be an HTTP request. It should be noted that while HTTP is used as an example protocol for a request to the API framework, HTTP over Secure Socket Layer (HTTPS) may also be used in various implementations described herein. Typically, the HTTP request specifies a Web application 155, a resource 156, and the format used by the standardized client 114, e.g. really simple syndication (RSS).

At step 310, the REST host 136 may create a resource request based on the client request. In one implementation, the REST host 136 may encapsulate the client request as an object within the resource request. In another implementation, the resource request may be a REST request.

Typically, a REST request uses the standard GET, POST, PUT, DELETE semantics of HTTP. It should be noted that other REST operations, such as HEAD (an optimized GET operation), and yet to be developed operations may be accommodated in various implementations described herein. Further, REST is merely one example of a methodology for sending application resource requests from the API framework server 122 to the application server 142. It should be noted that other methodologies/protocols, such as SOAP or binary XML may be used for sending application resource requests in various implementations described herein.

At step 315, the REST host 136 may determine whether the client 114 has valid security access for the requested resource 156. In one implementation, the REST host 136 determines the applicable policies 139 for the requested Web application 155 and restricts access to the application 155 and/or resources 156 by applying the policies 139. If the client 114 does not have valid security access, at step 340, the REST host 136 may send an error message to the client 114 and the method 300 terminates.

If the client 114 has valid security access, the method 300 continues. At step 320, the REST host 136 may send the REST request to the Web application 155. Accordingly, the Web application 155 may invoke a resource method for the specified resource 156 and action, such as PUT, POST, GET, DELETE, or HEAD.

At step 325, the REST host 136 may receive a response from the Web application 155. The response may include data 260 in response to a GET request. In one implementation, the response may include a status message indicating the success or failure of requests, such as a GET, PUT, POST, DELETE, or HEAD. In one implementation, the REST methods may return standardized numeric HTTP error or success codes (e.g., 200 for success).

At step 330, the REST host 136 may translate the response into one of the formats specified in the original HTTP request. In other words, the standardized client 114 may require responses in accordance with the format requested by the client 114.

In one implementation, translating the response may include serializing the data according to a data contract, or alternately, a custom serialization. The data contract may define the particular data that is serialized in the translated response. The type of serialization may depend on the requested format. For example, data contract serialization may be performed for JSON, XML, and binary XML formats. However, custom serializations, such as syndication-based serialization may be performed for RSS and ATOM formats. In either serialization scenario, the serialized data may then be included in the client response.

Accordingly, the client response may be created from the Web application response according to the format specified in the original HTTP request. At step 335, the REST host may send the translated response to the standardized client 114.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing access to a network application, comprising:
a) receiving a hypertext transfer protocol (HTTP) request from a standardized client to access the network application;
b) creating a resource request based on the HTTP request;
c) sending the resource request to the network application;
d) receiving a response from the network application;
e) creating a client response based on the response; and
f) sending the client response to the standardized client.

2. The method of claim 1, wherein steps (a)-(f) are performed by an application programming interface (API) framework.

3. The method of claim 2, wherein the resource request is a representational state transfer (REST) request.

4. The method of claim 3, wherein the network application is a Web application.

5. The method of claim 1, further comprising encapsulating the HTTP request as an object within the resource request.

6. The method of claim 1, wherein the response includes a status message that indicates success or failure of the resource request.

7. The method of claim 1, wherein the client response is created based on a format of the standardized client.

8. The method of claim 7, wherein creating the client response comprises translating the response into the format of the standardized client.

9. The method of claim 8, wherein translating the response comprises:
serializing data within the response based on the format of the standardized client; and
including the serialized data in the client response.

10. The method of claim 7, wherein the format is one of really simple syndication (RSS), ATOM Syndication, JavaScript Object Notation, extensible markup language (XML), or binary XML.

11. The method of claim 7, wherein the HTTP request specifies the network application, an application resource associated with the network application, and the format of the standardized client.

12. The method of claim 11, further comprising restricting access to the application resource based on a policy of the network application.

13. A computer system, comprising:
a processor; and
a memory comprising an application programming interface (API) framework executable by the processor to:
receive a hypertext transfer protocol (HTTP) request from a standardized client;
create a REST request based on the HTTP request;
send the REST request to a Web application;
receive a response from the Web application;
create a client response based on the response and a format of the standardized client;
send the client response to the standardized client; and
translate the response into the format of the standardized client.

14. The computer system of claim 13, wherein the API framework executable by the processor to translate the response is further executable to:
serialize data within the response based on the format of the standardized client; and
include the serialized data in the client response.

15. A computer-readable medium having stored thereon computer-executable instructions which, when executed by a computer, cause the computer to:
receive a hypertext transfer protocol over secure socket layer (HTTPS) request from a standardized client for accessing a network application;
create a representational state transfer (REST) request based on the HTTPS request;
send the REST request to the network application;
receive a response from the network application;
create a client response based on the response; and
send the client response to the standardized client.

16. The computer-readable medium of claim 15, further comprising computer-executable instructions, which, when executed by a computer, cause the computer to encapsulate the HTTPS request as an object within the REST request.

17. The computer-readable medium of claim 15, wherein the computer-executable instructions that cause the computer to create the client response further cause the computer to create the client response based on a format of the standardized client.

18. The computer-readable medium of claim 17, wherein the computer-executable instructions that cause the computer to create the client response, further cause the computer to translate the response into the format of the standardized client.

19. The computer-readable medium of claim 18, wherein the computer-executable instructions that cause the computer to translate the response, further cause the computer to:
serialize data within the response based on the format of the standardized client; and
include the serialized data in the client response.

20. The computer-readable medium of claim 17, wherein the HTTPS request specifies the network application, an application resource associated with the network application, and the format of the standardized client.
